(19) United States
(12) Patent Application Publication
(10) Pub. No.: US 2011/0283119 A1
(43) Pub. Date: Nov. 17, 2011

(54) System and Method for Providing Energy Efficient Cloud Computing

(75) Inventors: Hsing Chung SZU, Taipei City (TW); Jang Shang Wu, Taipei City (TW)

(73) Assignee: GCCA Inc., Road Town (VG)

(21) Appl. No.: 13/104,992

(22) Filed: May 11, 2011

Related U.S. Application Data
(60) Provisional application No. 61/395,458, filed on May 13, 2010.

(51) Int. Cl. G06F 1/26

(52) U.S. Cl. 713/300

(57) ABSTRACT

In one aspect, a cloud cube for providing energy efficient cloud computing is disclosed, which includes: an internal DC bus for transferring energy, clusters of computing servers coupled to the internal DC bus for performing cloud computing, at least one NAS storage coupled to the internal DC bus, at least one energy storage coupled to the internal DC bus, a plurality of energy sources coupled to the internal DC bus, and at least one energy manager coupled to the internal DC bus for performing energy management or energy routing.

In another aspect, a system for providing energy efficient cloud computing is disclosed, which includes: a DC grid having a plurality of interconnected energy sources, and a plurality of cloud cubes connected by the DC grid such that energy can be routed and shared among the cloud cubes.

### CROSS-REFERENCE TO RELATED APPLICATION

This application claims the benefit of U.S. Provisional Application No. 61/395,458, filed on May 13, 2010.

### TECHNICAL FIELD

The present invention generally relates to energy management of computing, and especially to a system and method for providing energy efficient cloud computing.

### DESCRIPTION OF THE RELATED ART

In pace with the technology, cloud computing is the trend in the future because it can lower the necessary quality of the hardware at the terminals of users. The technology of cloud computing is described as follows.

A data center is a facility used to house computer systems and associated components, such as telecommunications and storage systems. It generally includes redundant or backup power supplies, redundant data communications connections, environmental controls (e.g., air conditioning, fire suppression), and special security devices. Developing and maintaining these large data centers require both an initial capital expenditure and a regular operating budget. The cost of creating a data center is one of the major expenses involved in starting a new business—especially on online or Internet business.

Many firms have created data centers coupled to the Internet. Depending on the nature of the industry, these firms may also have surplus capacity. Firms have developed ways to sell this surplus capacity so that other enterprises can access this computing power. This Large-scale computing operation is often referred to as cloud computing. Cloud computing generally means Internet based development and use of computer technology. It is a method of computing where information technology (IT) related capabilities are provided as a service allowing users to access technology-enabled services over the Internet without knowledge of, expertise with, or control over the technology infrastructure that supports them.

Conventionally, cloud computing is a general concept that incorporates software as a service where the common theme is reliance on the Internet for satisfying the computing needs of the users. For example, suppliers of cloud computing services provide common business applications online that are accessed from a web browser, while the software and data is stored on the servers. The cloud computing infrastructure generally consists of services delivered through next-generation data centers that are built on computers and storage virtualization technologies. The services are accessible anywhere in the world, using the network as a single point of access for all the computing needs of clients.

Since clients do not own the infrastructure and are merely accessing or renting, they can avoid the initial capital expenditure and instead consume computing resources as a service. This allows them to only pay for the computing time and resources they actually use. Many cloud computing offerings have adopted the utility computing model which is analogous to how traditional utilities (like electricity) are consumed. By sharing computing power between multiple tenants, utilization rates can be improved because computers are not left idle. In turn, costs can be significantly reduced while increasing the speed of application development. An additional benefit of this approach is that computer capacity rises dramatically as customers do not have to engineer for peak loads.

There are two conventional types of energy storage technologies for cloud computing, one is used during power failure, or namely UPS, which is typically used in conjunction with power generators in data centers where continuing power supply may be accomplished; and another is used with power supply, where many users of power supply may get power from a utility/power company.

UPSs are designed to supply power for a short period of time, usually less than 10-15 minutes, so that computing devices may be shut down gracefully (without losing data or adversely interrupting user/processing). Power storage stations are designed for general power use but have not taken considerations for computing.

Furthermore, cloud computing may cause the environmental problem such as global warming which is one of the most important and urgent issue because of the discharge of carbon or carbide. Additionally, cloud computing may consume a great deal of energy because the severs, storages, networking, and cooling systems of cloud computing all have to be provided sufficient energy to process such a huge amount of data effectively.

Therefore, there is a need for a energy management solution, designed in consideration of continuing power supply (hours, days) and efficiency (both in use and supply, e.g., using renewable energy sources).

### SUMMARY

The present invention generally relates to energy management of computing, and especially to a system and method for providing energy efficient cloud computing so as to provide a energy management solution, thereby decreasing the discharge of carbon or carbide, alleviating the hurt caused by global warning, and reducing the energy consumption.

In a first aspect of the present invention, a cloud cube for providing energy efficient cloud computing is disclosed, which includes: an internal DC bus for transferring energy, clusters of computing servers coupled to the internal DC bus for performing cloud computing, at least one NAS storage coupled to the internal DC bus, at least one energy storage coupled to the internal DC bus, a plurality of energy sources coupled to the internal DC bus, and at least one energy manager coupled to the internal DC bus for performing energy management or energy routing.

In a second aspect of the present invention, a system for providing energy efficient cloud computing is disclosed, which includes: a DC grid having a plurality of interconnected energy sources, and a plurality of cloud cubes connected by the DC grid such that energy can be routed and shared among the cloud cubes.

In a third aspect of the present invention, a method of power management for a cloud cube is disclosed (hereinafter power management method), which includes: using solar PV at first priority; using batteries from a DC grid, if solar PV is not available; using DC sources, if the power level of the DC grid is below a high threshold; using AC sources, if the DC sources are not available; using energy storages of the cloud cube; performing a power saving mode when the power level of the energy storages is below a medium threshold; performing a super saving mode when the power level of the energy storages is below a medium-low threshold; performing a standby mode when the power level of the energy storages is below a low threshold; and increasing computing power, if the power level of the DC grid rises above the high threshold, or the power level of the energy storages rises above the medium threshold, or the power level of the energy storages rises above the medium-low threshold; and transferring energy from one cloud cube to another through the DC grid.

Through the power management method, energy may be recharged and stored in the DC grid or forwarded to the cloud cubes to maximize the efficiency of power distribution and use. Cloud cubes are connected by the DC grid, energy can be routed and shared among the cloud cubes to achieve higher level of reliability and fault tolerance in case of AC power failure.

In a fourth aspect of the present invention, a method for maximizing efficiency of cloud computing is disclosed (hereinafter task energy efficient method), which includes: performing power management means; and performing task scheduler means. And performing power management means includes: performing a power saving mode, if the power level of energy storages of the cloud cube is not greater than 50%; performing a standby mode, if the power level of energy storages of the cloud cube is not greater than 10%; exiting the standby mode and performing an energy saving mode, if the power level of energy storages of the cloud cube is greater than 15%; and exiting the energy saving mode, if the power level of energy storages of the cloud cube is not less than 55% and energy sources are available. Besides, performing task scheduler means includes using a computing server if the task type is “computing” or the memory requirement is not less than 4 GB; using general server with lowest utilization otherwise; scanning the server utilization; bringing the down server to the sleep mode if average utilization is less than 10% for 300 seconds; and bringing up more servers if average utilization is greater than 50% for 60 seconds.

Using the task energy efficient method, tasks can be directed to cloud cubes that the least amount of power is used for the most jobs accomplished. A “Task Energy” factor is assigned to each job, wherein the jobs which require more computation may cause higher energy consumption such that larger numerical “Task Energy” value can be assigned. When power saving is appropriate, such as during sunset or power failure, the task energy efficient method is used to enable energy efficient computing. Computing resources may be shutdown or put to stand-by mode. Computing tasks may be turned to power efficient PCs (low power PCs with less energy consumption) or under-utilized cubes or computing devices.

The present invention can be further understood by the following description of the preferred embodiment accompanying with the claims.

### BRIEF DESCRIPTION OF THE DRAWINGS

FIG. 1 shows an embodiment of the cloud cube of the present invention.

FIG. 2 shows a small scale system for providing energy efficient cloud computing.

FIG. 3 shows a large scale system for providing energy efficient cloud computing.

FIG. 4 shows a method of power management for a system of cloud cubes.

### DETAILED DESCRIPTION

Some sample embodiments of the invention will now be described in greater detail. Nevertheless, it should be recognized that the present invention can be practiced in a wide range of other embodiments besides those explicitly described, and the scope of the present invention is expressly not limited expect as specified in the accompanying claims.

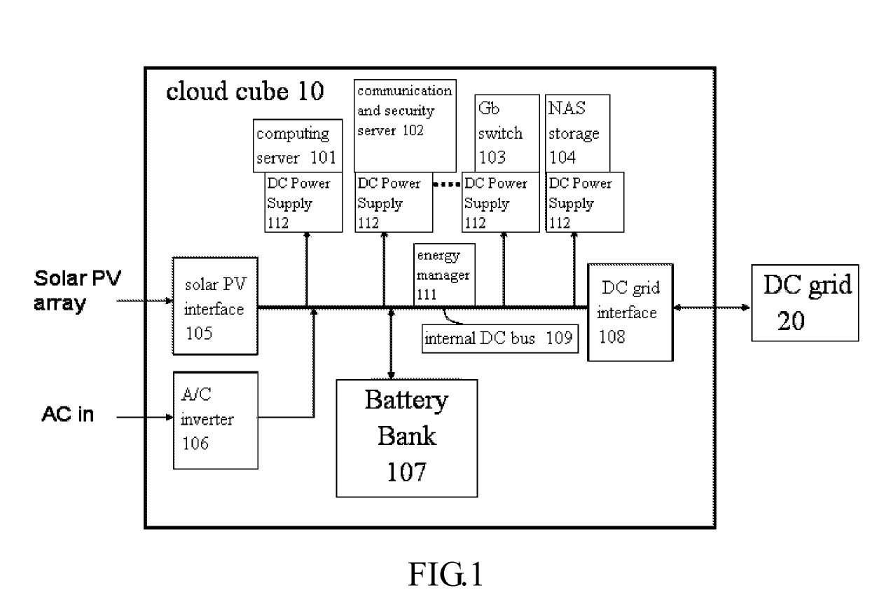

The preferred embodiment of the present invention is disclosed in FIG. 1, which relates to functional diagrams for a cloud cube 10 for providing energy efficient cloud computing. The cloud cube 10 includes an internal DC bus 109 for transferring energy, a computing server 101 coupled to the internal DC bus 109 for performing cloud computing, a communication and security server 102 coupled to the internal DC bus 109 to provide wire or wireless communication and defend against the attack from internet such as computer virus, or Trojan Horse. A Gb switch 103 (gigabit switch) is coupled to the internal DC bus 109 for increasing the transferring velocity, a NAS storage 104 (Network Attached Storage) coupled to the internal DC bus 109 for storing data, an energy storage 107 coupled to the internal DC bus 109, a solar PV interface 105 coupled to the internal DC bus 109 to offer solar energy. An A/C inverter 106 is subsequently coupled to the internal DC bus 109 to offer power from external power supply. A DC grid interface 108 is then coupled to the internal DC bus 109 so as to receive energy from the external DC grid 20, and an energy manager 111 coupled to the internal DC bus 109 for providing energy management or energy routing. Furthermore, the computing server 101, communication and security server 102, the Gb switch 103, and the NAS storage 104 further include a DC power supply 112 respectively for receiving power from the internal DC bus 109.

In the embodiment, the solar PV interface 105 can transform the solar energy received from external solar energy supply such as solar PV array to DC which can be used in the cloud cube 10, and the A/C inverter 106 can transform AC from external power supply such as a power generator or a power plant to DC either. The DC grid interface 108 is employed to receive the power from the DC grid 20 for the cloud cube 10, and the energy storage 107 is utilized to store the energy which is not used in the cloud cube 10, specifically, the energy storage 107 can be battery. The energy manager 111 may be a processor which can integrate and manage the energy from the solar PV interface 105, the A/C inverter 106, the energy storage 107, and the DC grid interface 108. One of the major tasks of the energy manager 111 is to determine which kind of energy sources mentioned above will be activated in various conditions according to the demand of users, which will be described hereinafter. Any person skilled in the art should understand that there may be more computing servers 101 for performing various functions and processing a great deal of data in the cloud cube 10.

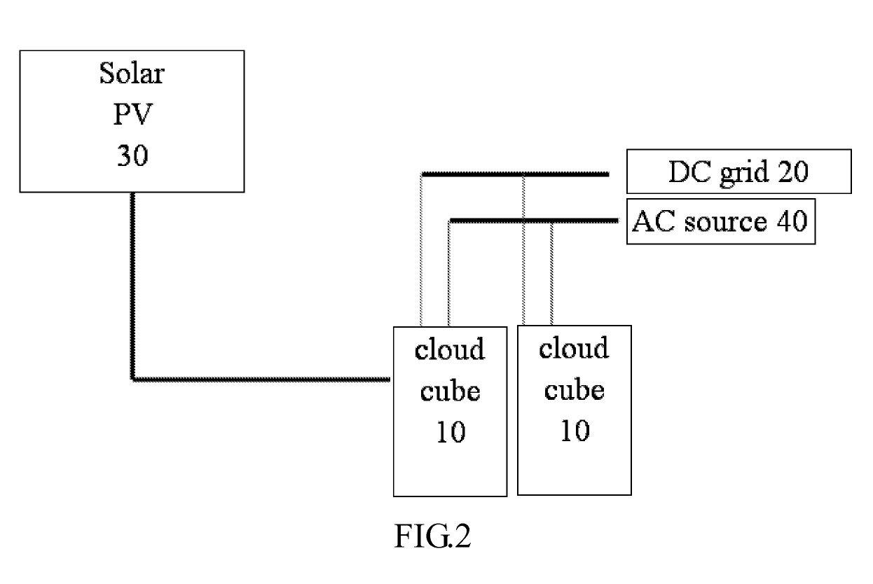

Another aspect of the present invention is disclosed, which relates to a system for providing energy efficient cloud computing including: a DC grid 20 having a plurality of interconnected energy sources; and a plurality of cloud cubes 10 connected by the DC grid such that the energy can be routed and shared among the cloud cubes. An embodiment is disclosed in FIG. 2, which relates to a small scale system for providing energy efficient cloud computing including: two cloud cubes 10, a DC grid 20, a solar PV 30, and an AC source 40, wherein the cloud cubes 10 are coupled to the DC grid 20, the solar PV 30 and the AC source 40 in parallel, and batteries are built in the cloud cubes 10 as the energy storage 107 such that energy from the DC grid 20, the solar PV 30, and the AC source 40 can be saved and the saved energy can be introduced when the DC grid 20, the solar PV 30, and the AC source 40 are unavailable.

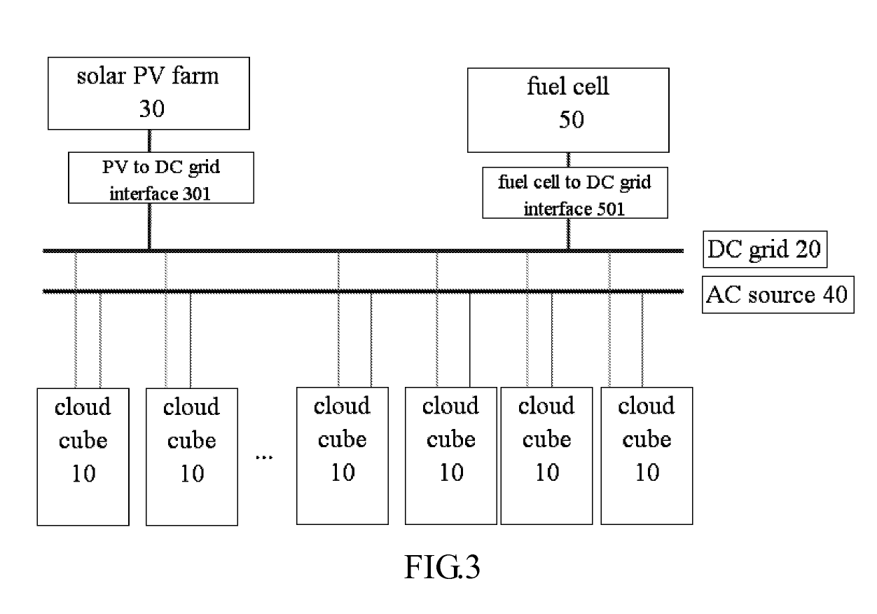

Another embodiment is disclosed in FIG. 3, which relates to a large scale system for providing energy efficient cloud computing including: a plurality of cloud cubes 10, a DC grid 20, a solar PV farm 31, an AC source 40, a fuel cell 50, a PV to DC grid interface 301, a fuel cell to DC grid interface 501, wherein solar energy can be received by the solar PV farm 31 which comprises a large amount of solar PV 30, and then can be transformed to DC which is compatible in the DC grid 20 by the PV to DC grid interface 301 and transferred to the DC grid 20, and the energy which is generated by the fuel cell 50 can be transformed to DC by the fuel cell to DC grid interface 501 and transferred to the DC grid 20. Specifically, the PV to DC grid interface 301 and the fuel cell to DC grid interface 501 may be an inverter. In the embodiment, the plurality of cloud cubes 10 are coupled to the DC grid 20 in parallel, additionally, they are coupled to the AC source 40 in parallel either, thereby the energy from the DC grid 20 including the solar energy and the fuel cell energy, and the energy from AC source 40 can be introduced to the cloud cubes 10 respectively. Additionally, the energy in each of the cloud cubes 10 can be transferred and shared through the DC grid 20 such that consumption of energy can be decreased, therefore, the whole efficiency can be increased higher than conventional system of cloud computing which is operated independently.

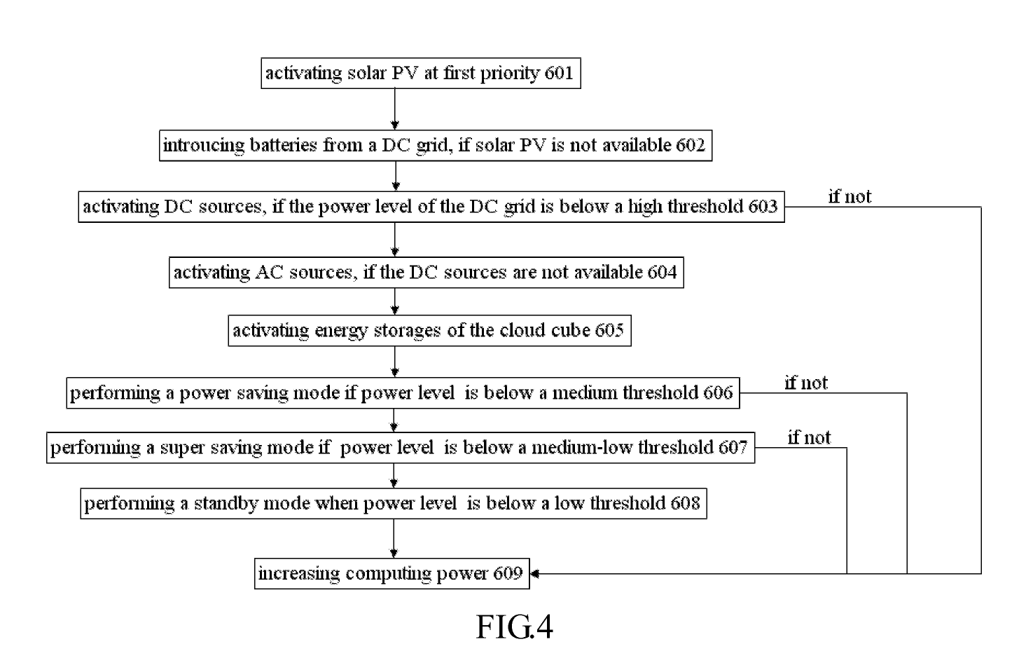

In a further aspect of the current invention, a method of power management for a cloud cube is disclosed in FIG. 4, which is described as follows: In step 601, the solar PV is activated by the energy manager of the cloud cube at first priority. The batteries from a DC grid are introduced by the energy manager of the cloud cube in step 602, if solar PV is not available. Please refer to step 603, the DC sources are activated by the energy manager of the cloud cube if the power level of the DC grid is below a high threshold. If the DC sources are not available, the AC sources will be activated by the energy manager of the cloud cube as shown in step 604; Please turn to step 605, energy storages of the cloud cube are activated by the energy manager of the cloud cube; in step 606, the cloud cube is instructed to perform a power saving mode by scaling down computing power when the power level of the energy storages is below a medium threshold. In step 607, when the power level of the energy storages is below a medium-low threshold, the cloud cube will be instructed to perform a super saving mode by further scaling down computing power. Next, please turn to step 608, a standby mode will be processed by the cloud cube when the power level of the energy storages is below a low threshold; and in step 609, increasing computing power, if the power level of the DC grid rises above the high threshold, or the power level of the energy storages rises above the medium threshold, or the power level of the energy storages rises above the medium-low threshold. In aforementioned method, the priority of energy sources is that solar PV 30 is prior than batteries in the DC grid 20, batteries in the DC grid 20 are prior than DC sources in the DC grid 20, DC sources in the DC grid 20 are prior than the AC source 40, and the AC source 40 are prior than the energy storage 107. And, for example, the level of high threshold is about 60%, the level of medium threshold is about 50%, the level of medium low threshold is about 30%, and the level of low threshold is about 10%. Additionally, energy can be transferred form one cloud cube to another. However, it should be noted that any person skilled in the art can understand that aforementioned priority of energy sources can be changed and the level of threshold can be determined according to necessity of users.

In a further aspect, a method for maximizing the efficiency of cloud computing (hereinafter task energy efficient method) is disclosed, which includes: performing power management means; and performing task scheduler means. Specifically, the method of performing power management means is described as follows: the cloud cube is instructed to perform the power saving mode if the battery level is less than 50%, the cloud cube is instructed to perform the stand-by mode if the battery level is less than 10%, the cloud cube will be instructed to halt the stand-by mode and to perform the power saving mode if the battery level is greater than 15%, and the cloud cube will be instructed to halt the power saving mode and to resume full function if the battery level is greater than 55% and energy sources are available, wherein aforementioned energy sources includes solar PV, DC, AC, and battery. And performing power saving mode comprises the steps of: turning off idle severs, turning off servers with max power consumption, and keeping storage servers, networking switches, and admin servers alive. And performing stand-by mode comprises the steps of: turning off all servers; and keeping admin servers and networking link alive. Additionally, performing task scheduler means comprises the steps of: using computing servers if the task type is computing, using the computing servers if the task memory requirement is greater than 4 GB, using general servers with lowest cpu utilization otherwise, scanning server utilization, bringing down servers to a sleep mode if average utilization is less than 10% for 300 seconds, awaking the servers if average utilization is greater than 50% for 60 seconds. However, it should be noted that any person skilled in the art can change and choose another battery level according to the necessity of users.

By aforementioned task energy efficient method, tasks can be directed to cloud cubes that the least amount of power is used for the most jobs accomplished. A “Task Energy” factor which is a value depending on required energy of computing may be calculated by the processor in the cloud cube and can be assigned to each job, wherein the jobs which require more computation may cause higher energy consumption such that larger “Task Energy” value will be assigned. Consequently, energy can be managed and distributed appropriately based on the “Task Energy” factor. When power saving is appropriate, such as during sunset or power failure, the task energy efficient method is used to enable energy efficient computing. Computing resources may be shutdown or put to stand-by mode. Computing tasks may be turned to power efficient PCs (low power PCs with less energy consumption) or under-utilized cubes or computing devices.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example of the present invention. Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. It should be appreciated that in the foregoing description of exemplary embodiments of the present invention, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims are hereby expressly incorporated into this description, with each claim standing on its own as a separate embodiment of this invention.

What is claimed is:

1. A cloud cube for providing energy efficient cloud computing including:
an internal DC bus for transferring energy;
clusters of computing servers coupled to said internal DC bus for performing cloud computing;
at least one NAS storage coupled to said internal DC bus;
at least one energy storage coupled to said internal DC bus;
a plurality of energy sources coupled to said internal DC bus; and
at least one energy manager coupled to said internal DC bus for performing energy management or energy routing.

2. The cloud cube according to claim 1, wherein said energy storage is a battery.

3. The cloud cube according to claim 1, wherein said energy sources comprises AC sources, DC grid, and solar PV.

4. The cloud cube according to claim 3, wherein said DC grid comprises a plurality of interconnected energy sources including external batteries, renewable energy sources, AC sources, and DC sources, whereby forming a power storage and distribution system.

5. The cloud cube according to claim 4, wherein said renewable energy sources comprises solar PV.

6. The cloud cube according to claim 4, wherein said renewable energy sources comprises fuel cells.

7. A system for providing energy efficient cloud computing including:
a DC grid having a plurality of interconnected energy sources; and
a plurality of cloud cubes connected by said DC grid such that energy can be routed and shared among said cloud cubes.

8. The system according to claim 7, wherein each of said cloud cube further comprises computing severs, a communication and security server, a NAS storage, an energy storage, and an energy manager.

9. The system according to claim 7, wherein said DC grid comprises at least one battery configured in each of said cloud cubes, renewable sources, AC sources, and DC sources.

10. The system according to claim 9, wherein said renewable sources comprise solar PV.

11. The system according to claim 9, wherein said renewable sources comprise fuel cells.

12. A method of power management a cloud cube, which includes:
activating solar PV by a energy manager of said cloud cube at first priority;
introducing batteries from a DC grid by said energy manager of said cloud cube, if solar PV is not available;
activating DC sources by said energy manager of said cloud cube, if the power level of said DC grid is below a high threshold;
activating AC sources by said energy manager of said cloud cube, if said DC sources are not available;
activating energy storages of said cloud cube by said energy manager of said cloud cube;
instructing said cloud cube to perform a power saving mode when the power level of said energy storages is below a medium threshold;
instructing said cloud cube to perform a super saving mode when the power level of said energy storages is below a medium-low threshold;
instructing said cloud cube to perform a standby mode when the power level of said energy storages is below a low threshold; and
increasing computing power, if said power level of said DC grid rises above said high threshold, or said power level of said energy storages rises above said medium threshold, or said power level of said energy storages rises above said medium-low threshold.

13. The method according to claim 12, further includes transferring energy from one cloud cube to another through said DC grid.

14. The method according to claim 12, wherein said power saving mode is performed by scaling down said computing power.

15. The method according to claim 14, wherein said super saving mode is performed by further scaling down said computing power.

16. The method according to claim 12, wherein said standby mode is performed as only an admin server is running.

17. A method for maximizing efficiency of cloud computing, which includes:
performing power management means;
performing task scheduler means.

18. The method according to claim 17, wherein said performing a power management means comprises the steps of:
entering a power saving mode if the battery level is less than 50%;
entering a stand-by mode if the battery level is less than 10%;
exiting said stand-by mode and entering a power saving mode if the battery level is greater than 15%; and
exiting said power saving mode and resuming full function if the battery level is greater than 55% and energy sources are available.

19. The method according to claim 18, wherein entering a power saving mode comprises the steps of:
turning off idle severs;
turning off servers with max power consumption; and
keeping storage servers, networking switches, and admin servers alive.

20. The method according to claim 18, wherein entering a stand-by mode comprises the steps of:
turning off all servers; and
keeping admin servers and networking link alive.

21. The method according to claim 18, wherein said energy sources comprise solar PV, AC sources, and DC sources.

22. The method according to claim 17, wherein said performing task scheduler means comprises the steps of:
using computing servers if the task type is computing;
using said computing servers if the task memory requirement is greater than 4 GB;
using general servers with lowest cpu utilization otherwise;
scanning server utilization;
bringing down servers to a sleep mode if average utilization is less than 10% for 300 seconds;
awaking said servers if average utilization is greater than 50% for 60 seconds.
